(19) United States
(12) Patent Application Publication
(10) Pub. No.: US 2006/0085202 A1
(43) Pub. Date: Apr. 20, 2006

(54) Method and a system for responding to a request for access to an application service

(76) Inventors: Bjorn Sahlberg, Stockholm (SE); Helena Holmgren, Johanneshov (SE)

Correspondence Address: BIRCH STEWART KOLASCH & BIRCH, PO BOX 747, FALLS CHURCH, VA, 22040-0747, US

(21) Appl. No.: 10/541,236

(22) PCT Filed: Dec. 23, 2003
(86) PCT No.: PCT/SE03/02069

§ 371 Date: Jul. 1, 2005

Related U.S. Application Data
(60) Provisional application No. 60/438,767, filed on Jan. 9, 2003.

(30) Foreign Application Priority Data
Jan. 3, 2003 (SE) 0300013-0

(51) Int. Cl. G06Q 99/00

(52) U.S. Cl. 705/1

(57) ABSTRACT

The present invention relates to a method and a server for responding to a request for access to an application service, which service is deployed in a system that associates specific areas of a position coded surface with corresponding application services. According to the invention, an enterprise paper look-up service E-PLS1 is provided which manages a confined set of enterprise application services E-AS1 associated with respective areas included by the overall position coded surface. When receiving a request that includes address information of such an area, the enterprise paper look-up service E-PLS checks if the area address is associated with a service that the E-PLS manages. If this is not the case, the request is routed to a second paper look-up service E-PLS2.

### TECHNICAL FIELD

The present invention relates to a method and a server for responding to a request for access to an application service, which service is deployed in a system that associates specific areas of a position coded surface with corresponding application services.

### BACKGROUND OF THE INVENTION

The applicant of the present invention has developed a system infrastructure in which use is made of products having writing surfaces that are provided with a position code. Digital devices, preferably in the form of digital pens, are used for writing on the writing surface while at the same time being able to detect positions of the position coded surface. The digital device detects the position code by means of a sensor and calculates positions corresponding to written pen strokes.

An area of the position code, such as an area associated with a product, typically has one or more activation icons, also known as magic boxes, which, when detected by the digital device, cause the pen to initiate a respective predetermined operation which utilises the information recorded by the device from the position coded surface.

More specifically, the position-coded surface has a built-in functionality, in that different positions on a confined area of the surface on a product, such as positions within the activation icon and positions within the writing surface, are dedicated for different functions. The position code is capable of coding coordinates of a large number of positions, much larger than the number of necessary positions on a surface area of one single product. Thus, the position code can be seen as forming a virtual surface which is defined by all positions that the position code is capable of coding, different positions on the virtual surface being dedicated for different functions, or services, and/or actors.

The system includes, in addition to the digital devices and a plurality of position coded products, at least one look-up server running a service called a paper look-up service, PLS, and a plurality of application servers acting as actors or Application Service Handlers ASH in the system and executing application services.

The look-up server uses a database to manage the virtual surface defined by the position code and the information related to this virtual surface, i.e. the functionality of every position on the virtual surface and the actor associated with each such position. Different areas, or regions, on the virtual surface are by the paper look-up service associated with respective particulars and/or data by means of management rules. In response to receipt of information from a digital device, which information corresponds to at least one position on the virtual surface, the PLS is arranged to identify to which area the coordinates of the position or positions belong and to determine how the information is to be managed based on the management rules for that area.

The application server is a server effecting a service on behalf of a digital device, such as storing or relaying digital information, initiating transmission of information or items to a recipient etc.

The above described position coded surface and the overall system with its operation and its enabling support of various functions and services to digital devices are further described in the published patent applications U.S. 2002/0091711, U.S. 2003/0046256 and U.S. 2003/0061188, all of which have been filed by the present applicant and all of which are incorporated herein by reference. It is to be noted that other types of position codes are equally possible within the scope of the present invention.

The above described system is beneficial for an enterprise or a government authority that wants to use the functionality of the system for improving internal processes and workflows. By using the described system, an enterprise will be able to turn information entered by means of pen and paper into useful digital data. Such a process for transferring paper based information to digital data will save the enterprise a considerable amount of labour and time, and in the end a considerable amount of money.

However, there are some drawbacks associated with the above system if an enterprise wants to adopt the system while at the same time, for security reasons, retaining full control over its usage. Some of these drawbacks can be derived from the fact that the above described paper look-up service is a global service, i.e. a global paper look-up service, G-PLS, that services a number of different actors and that is operated by an external party, typically by the party determining the allocation of different areas of the position coded surface to different functions and different actors.

The enterprise can gain more or less full control over any application services which are for exclusive use by the enterprise and its associated pens if the application services are hosted on e.g. an intranet, without any participation of the global paper look-up service in the execution of the specific application service. However, the enterprise would still be dependent on an established communication with the global PLS, such as over the Internet, in order for the look-ups from the digital devices, or pens, to be managed correctly and in order to direct a device to a specific application service. Thus, the enterprise will not be in control of general digital device usage, such as look-ups being performed, nor will it then be able to control the digital device's access to externally available services, since such services could be accessed by the digital devices via the global PLS.

### SUMMARY OF THE INVENTION

An object of the present invention is to provide a method and a server that offers an enterprise increased control and security, in terms of general system usage and service usage, when adopting the principles of a position coded paper based system of the kind described above.

According to the invention, this object is achieved by a method having the features as defined in independent claim 1 and by an enterprise paper look-up server having the features as defined in independent claim 16. Preferred embodiments of the invention are defined in the dependent claims.

The invention is based on the idea that instead of relying on a global paper look-up service for managing information and controlling and invoking application services, an enterprise paper look-up service is provided which manages a confined set of enterprise application services associated with respective areas included by the overall position coded surface. When receiving a request that includes address information of such an area, the enterprise paper look-up service, E-PLS, checks if the area address is associated with a service that the E-PLS manages. The E-PLS also checks if the originator of the request has the right to access the enterprise application service. If the area address is not associated with a service managed by the E-PLS, the request is routed to a second paper look-up service.

This solution provides a number of advantages. The solution improves security since it enables the enterprise paper look-up service to operate independently of the global PLS, and therefore only requires communication within an internal network of the enterprise, to which network one or more enterprise paper look-up services and servers executing enterprise application services are connected. Thus, the enterprise does not need to communicate with a global PLS over the Internet. By not including Internet resources in the solution the security and control of the system is not jeopardized. Should it be desired to be able to communicate with the global PLS, such communication can be greatly restricted and carefully monitored by means of communication via an enterprise firewall. Also, the system can more easily be adapted to any existing security framework of the enterprise.

Furthermore, the enterprise will be in full control over what services that can be accessed by the digital devices, and thus in full control over the usage of the digital devices in the system. It is the enterprise that on its own determines what confined set of services that are managed by the enterprise look-up service and what specific further look-up service a service request may be routed to. In addition to the fact that this gives the enterprise control over what services that are, and can be, used, it also facilitates the control of costs generated by the system usage. The solution enables an enterprise centralized administration, and enables introduction of new services and maintenance of services to be performed easily and efficiently by the enterprise, since the services are managed centrally and provided so as to be accessible to all digital devices associated with the enterprise.

Advantageously, the E-PLS checks if an originator of a request for access to a service has the right to route a request via the present E-PLS to a second PLS, before such routing is performed. The right may be controlled by, e.g., different security levels associated with the services of the second PLS or the second PLS in itself. This second PLS may be an E-PLS of another organisational part of the same enterprise, an E-PLS of another enterprise, or the global PLS. Thus, regardless of whether the originator is a digital device or another E-PLS, this makes it possible to enable, or disable, the access to an E-PLS of another organisational part of the same enterprise, an E-PLS of another enterprise, or to the global PLS if such a communication path is possible.

Furthermore, the E-PLS advantageously checks, if the received request for access to a service is determined to relate to a service managed by the E-PLS itself, that the digital device has the right to access this specific service, before granting access to the service. Thus, the enterprise will be able to control what digital device, or group of digital devices, that is/are allowed to access what service. Similarly, the E-PLS may check if a certain other E-PLS has the right to route a request for access to a service managed by the E-PLS in case the request is received from such other E-PLS.

Further features and advantages of the invention will become more readily apparent from the following detailed description of a number of exemplifying embodiments of the invention. As is understood, various modifications, alterations and different combinations of features coming within the spirit and scope of the invention will become apparent to those skilled in the art when studying the general teaching set forth herein and the following detailed description.

### BRIEF DESCRIPTION OF THE DRAWINGS

Exemplifying embodiments of the present invention will now be described with reference to the accompanying drawings, in which:

FIG. 1 schematically shows an exemplifying system infrastructure developed by the applicant of the present invention;

FIG. 2 schematically shows a system which includes an exemplifying embodiment of the present invention;

FIG. 3 shows an enterprise paper look-up server in accordance with an exemplifying embodiment of the invention;

FIG. 4 schematically shows an exemplifying overall operation which includes the operation of an embodiment of the invention; and

FIG. 5 is a flow chart of the operation in accordance with an exemplifying embodiment of the invention.

### DETAILED DESCRIPTION OF THE INVENTION

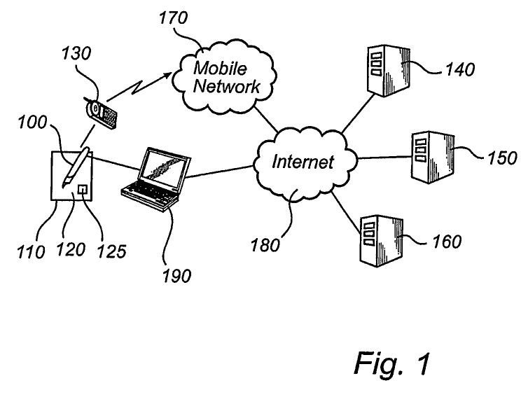

FIG. 1 shows the system infrastructure developed by the applicant of the present invention. This infrastructure has been described above in the background section and will be further described below.

The system in FIG. 1 comprises digital pens 100 implementing digital devices and a plurality of products 110 with a position code (not shown) covering a writing surface 120 and an activation icon 125. In the figure, only one digital pen and one product are shown. The system further comprises a network connection unit 130, a paper look-up server 140 running a paper look-up service, PLS, an application server 150 running an application service of a third party and an application server 160 running a number of standardized application services in the system. In FIG. 1 the network connection unit 130 is exemplified with a mobile station, however, the unit 130 could alternatively be a personal digital assistant (PDA) or some other suitable electronic device. Typically, the described system will in addition to a plurality of digital devices 100 and products 110 include a plurality of network connection units 130 and a plurality of application servers 150, 160.

By detecting symbols of the coding pattern on the product 110, the digital pen is able to determine one or more absolute co-ordinates of the total, virtual surface that can be coded by the coding pattern.

The total surface is advantageously divided into a number of segments, each segment being divided into a number of shelves, each shelf being divided into a number of books, and each book being divided into a number of pages. An absolute co-ordinate, i.e. a global position on the total, virtual surface, will by the digital pen be determined to be located on a certain page, which page may be regarded as a logical page having local positions. The page may be identified using the format 1.2.3.4 (segment.shelf.book.page), which denotes page 4 of book 3, on shelf 2, in segment 1. This notation defines a page address. An area address may typically be defined by a page address. However, an area address may also define a larger area by means of a book address, e.g. 1.2.3.x, where x denotes all pages of the specific book, a shelf address, 1.2.x.x, or a segment address, 1.x.x.x. It is to be understood that other addressing schemes are equally possible and that such addressing schemes also would fall within the scope of the present invention.

When the user moves the digital pen 100 across the surface of the product 110, information is recorded by detecting code symbols on the surface and determining the corresponding absolute co-ordinates. This is accomplished by means of a sensor and various memory and processing circuitry included within the pen 100. These absolute coordinates, or the area address, typically the page address, to which the co-ordinates belong, are communicated via the mobile station 130, a mobile communications network 170 and the Internet 180 to the paper look-up service 140. Alternatively, the coordinates are communicated to a local paper look-up service running on a personal computer, PC, 190 in the close neighbourhood of the digital pen. If the personal computer and the digital pen are equipped with Bluetooth® transceivers, the digital pen 100 may communicate directly with the PC running the local PLS.

The local PLS is responsible for managing and providing local standardized application services, such as an e-mail application, a calendar application, an application for taking notes etc. The local PC 190 stores particulars about co-ordinates and pages of one or more confined surface areas and manages services on behalf of one or a very limited number of digital pens. The paper look-up service running on server 140 on the other hand is global and stores, in a memory or in a connected data base (not shown), particulars about all the co-ordinates of the total surface. This also includes storing particulars about the pages in which the total surface is divided. Both the global and the local paper look-up service process received information, which at least include co-ordinate content or page address content, in accordance with the management rules that have been associated with a particular co-ordinate or a particular page address.

For a user of a digital pen, the system is simple to use as the user does not himself need to define how recorded information/positions are to be managed. When the user initiates a communication session for transmission of information, the management of this information is controlled based on the co-ordinates that the user records and/or the page address on which the information was recorded by means of the digital pen 100.

When the user of the digital pen 100 wishes to initiate transmission of information he “ticks” the activation icon 125. The recording of at least one position of the activation icon will then be recognised by the digital pen 100 as a co-ordinate of a send area, which send area is associated with a particular send instruction. By default, this send instruction includes the address of a predefined paper look-up service, either the global service of server 140 or the local service of the PC 190. Alternatively, two send areas may exist, one associated with the global service and one with the local service.

The digital pen 100 and the global/local paper look-up service communicate by means of a pen protocol which is a proprietary protocol of the applicant of the present invention. For a more detailed description of the pen protocol and the communication between a digital pen and a paper look-up service reference is made to the patent application U.S. 2003/0055865, which is incorporated herein by reference.

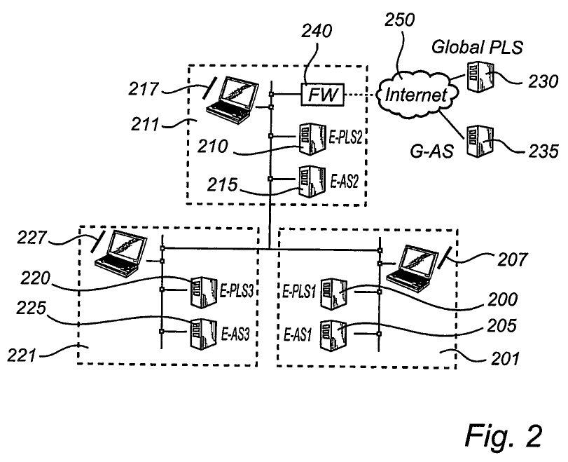

FIG. 2 schematically shows a system which includes an embodiment of the present invention. The system has a hierarchical configuration with three enterprise paper look-up servers 200, 210, 220, executing respective enterprise paper look-up services E-PLS1, E-PLS2, E-PLS3, and three application servers 205, 215, 225, executing respective confined sets of enterprise application services E-AS1, E-AS2, E-AS3.

Each enterprise service manages its own pens 207, 217, 227, registered with the service and its own application services. Typically, an enterprise paper look-up service manages enterprise application services that are executed on an application server which is connected to the server of the enterprise paper look-up service over a local area network. Thus, E-PLS1, with which pens 207 are registered, and which executes on server 200, manages E-AS1 executing on server 205, and E-PLS2, with which pens 217 are registered, manages E-AS2, and so on.

FIG. 2 also depicts a global paper look-up server 230 executing a global paper look-up service, G-PLS, and an application server 235 executing application services which also can be regarded as being global, and therefore denoted G-AS. In the figure, E-PLS2 is able to communicate with the G-PLS over an enterprise firewall 240 and the Internet 250.

The operation of an enterprise paper look-up service is similar to that of the global paper look-up service, the latter sometimes only referred to herein as paper look-up service, PLS. The E-PLS distinguishes itself from the G-PLS in that it, e.g., may be configured to only communicate within a local area network (LAN) or to only communicate within the LAN and with one or more specific secondary E-PLSs outside the LAN. Such a secondary E-PLS may belong to the same enterprise or a different enterprise. Of course it is possible that the E-PLS and a secondary E-PLS are connected to the same LAN or a same Wide Area Network. In FIG. 2, even though not depicted, E-PLS1 and E-AS1 could be connected to a LAN without any connections to any other servers, and, thus, defining an enterprise's 201 own, isolated, version of the system infrastructure developed by the present applicant and as described above. As a further example, E-PLS1, E-PLS2 and E-PLS3 could be the PLSs of respective parts of the same enterprise sharing the same LAN or having their own LANs which are interconnected with each other.

Another difference between an E-PLS and the G-PLS is that it is the enterprise itself that is responsible for operation, maintenance, support and administration of its own enterprise paper look-up server. Thus, the enterprise itself administers the database used for storing management rules related to its enterprise application services, registration and maintenance of its associated digital pens, availability of internal and external application services, access rights to internal and external application services etc.

It is more efficient for an enterprise to use an E-PLS than to use a number of local paper look-up services. If the enterprise were to use a number of PCs executing local paper look-up services, access to general application services within the enterprise could only be accomplished with additional software on each client machine executing the local PLS, something which makes the system more difficult to support and administrate, in particular in terms of adding nodes or services in the system.

Furthermore, by using local PLSs, there would be no simple way of accessing the enterprise services through any other node than the PC implementing the local PLS, something which would put limits on a pen user's possibility to connect to the internal network and access an enterprise application service via a mobile station and a mobile communication networks in a manner as described above.

Advantageously, the communication between a digital pen and an E-PLS is secure and based on, e.g., a symmetric encryption key that is unique for each pen. The E-PLS is also arranged to be able to perform authentication of a digital pen. Similarly, the communication between different E-PLSs, or possibly involving the G-PLS, is secure by means of encryption keys, and an E-PLS is able to authenticate another E-PLS.

In FIG. 2, the possibility of connecting E-PLSs in a hierarchy has been illustrated. In this exemplified hierarchy, an E-PLS is able to communicate with the G-PLS over a firewall 240 and an external network in the form of the Internet 250. The E-PLSs of the hierarchy could belong to different enterprises or to different divisions/departments within the same enterprise.

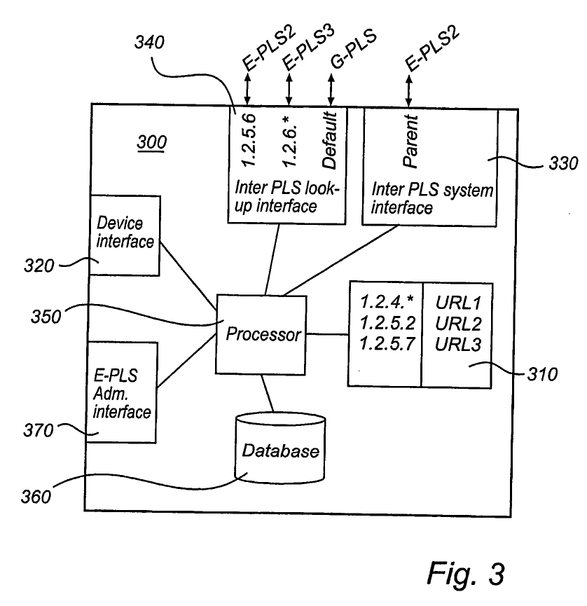

FIG. 3 shows an enterprise paper look-up server 300 in accordance with an exemplifying embodiment of the invention. The E-PLS 300 shown in FIG. 3 may, e.g., be configured to execute either one of the enterprise paper look-up services E-PLS1, E-PLS2 or E-PLS3 in FIG. 2. The enterprise paper look-up server 300 includes first storing means 310, interface means 320, 340, second interface means 330, second storing means 340 and processing means 350. First and second storing means may be implemented by means of any readily available memory device, such as RAM, ROM or the like or a hard disk drive. The different interface means may be implemented by any kind of interface hardware circuitry which enable the paper look-up server to communicate by means of a TCP/IP protocol stack or any other protocol stack implementing a commercial or proprietary protocol chosen for the communication with the various entities as described below. The processing means may be implemented by any suitable, commercially available microprocessor, or, alternatively, an Application Specific Integrated Circuit, or corresponding circuit, specifically designed for controlling the functioning of the paper look-up server.

The processing means 350 executes a look-up service which, in correspondence with the operation of a G-PLS, operate to map a certain area of the coding pattern, such as the area defining an activation icon, to a network address, such as a URL on an Intranet, for a certain application service. A database 360 accessed by the processing means is used for storing management rules and various data defining and controlling associations between different coded surface areas and different enterprise application services managed by E-PLS 300. The database 360 also stores information controlling which pens that have the right to access which services.

In a simple configuration, the first storing means 310 is implemented by means of a table in which an area address entry of the table corresponds to a specific URL of an application service associated with the area address. The table is either stored in a separate memory circuit or in the database 360. For example, it is shown in FIG. 3 that the surface area defined by all pages of segment 1, shelf 2, book 4 (denoted 1.2.4.*) is associated with URL1, and that the specific page denoted 1.2.5.2 is associated with URL 2. URL 1 and URL 2 are the network addresses of application services executed by the same, or two different, enterprise application servers connected to the same local enterprise network as the E-PLS 300, i.e. to the same Intranet or at least the same LAN.

The interface means 320 is a device interface which is arranged to communicate with digital devices, e.g. digital pens. As described above, this communication uses a proprietary pen protocol, PP, which in turn uses the proprietary secure pen protocol, SPP, and the hypertext transfer protocol, http. Typically, this device interface is used by the E-PLS 300 for receiving requests from its registered digital pens, which requests include area addresses defining certain position coded areas, and for responding to the digital pens with information relating to application services associated with these area addresses, such information at least including the network address, such as an URL, to be used for accessing the service. This information may typically also include such things as what kind of data that the device is required to transmit to the application service in order for the service to be executed, e.g. user data stored in the pen or data recorded from a certain writing surface area.

The interface means 340 is also known as an Inter PLS look-up interface and is used for communication between different PLSs. The Inter PLS look-up interface 340 is in the figure depicted as including stored associations between different area addresses and E-PLS/G-PLS. In practice, these associations are stored by the second storing means being located anywhere in server 300 and accessible by the processing means 350, either in a separate memory circuit or in the database 360.

The E-PLS 300 uses the Inter PLS look-up interface 340 when it cannot find an application service associated with an area address of a received request in the first storing means 310. The request is then routed to a second PLS, either another E-PLS or the G-PLS, in accordance with the associations stored by the second storing means 340. The routing is performed by the processing means 350 by way of operating on the second storing means 340. Thus, the combination of the processing means 350 and the second storing means 340 forms the routing means of the E-PLS 300. The second storing means 340 may also include a network address of a default E-PLS to which a request may be routed. This default E-PLS may constitute the only second E-PLS to which requests can be routed, or it can co-exist with other secondary PLSs and be used when there is no other secondary PLS that is associated with an area address of the request which is to be routed.

Furthermore, the E-PLS may also receive requests over the Inter PLS look-up interface, which requests have been routed from another E-PLS. In the same way as when receiving a request over the device interface 320, the E-PLS 300 will check in the first storing means 310 for an application service associated with the area address of such a request from another E-PLS. If such application service is found, the network address thereof is returned to the requesting E-PLS. The E-PLS will also examine a list of E-PLS identities received in a request. These identities indicate which E-PLSs that have been traversed by the request. If the E-PLS receiving the request finds its own identity in the list, this indicates that a loop has occurred among the E-PLSs. The request will then be denied, thereby resolving the loop.

The parameters that the E-PLS 300 may receive in a request, or look-up request, over the Inter PLS look-up interface 340, and which has been routed from another E-PLS, are exemplified in the non-exhaustive list below.

| Request parameter | Description |
|---|---|
| requesterId | the identity of the device. |
| transactionId | the identity of the transaction that triggered |
| | the request. |
| penId | the identity of the pen that triggered the |
| | request. |
| visited Ids | the identities of the PLSs traversed by the |
| | request. |
| pageAddress | the page address derived from the pen stroke |
| | that triggered the request. |
| magicBoxId | the identity of the activation icon in which |
| | pen stroke were made to trigger the request. |

The information that the E-PLS may return over the Inter PLS look-up interface 340 to the requesting E-PLS are exemplified in the non-exhaustive list below.

| Information element | Description |
|---|---|
| status | indicates status of service, e.g. locked, |
| | not active, not found, access denied. |
| name | the name of the service as presented to a |
| | pen user. |
| URL | the URL for the application service. |
| security | the level of security imposed by the |
| | application service, e.g. no security, or |
| | encryption with supplied key. |
| ticket | an authentication ticket if such security |
| | is required. |
| key | a public key used if security implies |
| | encryption. |
| read | data stored by the pen, so called pen |
| | properties, which the service can read. |
| mand | mandatory pen properties that the service |
| | requires. |
| licensedPattern | a page address defining what surface area |
| | the service can read from. |

As is understood, the PLS associations stored in the second storing means 340 are configurable and will define the position of E-PLS 300 in a hierarchy of E-PLSs. Thus, by means of the second storing means and the Inter PLS look-up interface, E-PLS 300 may be configured to operate as either one of E-PLS1, E-PLS2 or E-PLS3 shown in FIG. 2.

The second interface means 330 is an Inter PLS system interface via which the E-PLS 300, e.g. at regular intervals, can ask its parent PLS for template updates. For example, in the hierarchy in FIG. 2, E-PLS2 is a parent PLS to E-PLS1 and to E-PLS3. This hierarchy is predefined upon configuration of the E-PLSs in the system by means of allocating, if desired, a parent PLS to an E-PLS. Upon receiving a template update in a response from the parent PLS over the same interface, the processing means 350 can extract e.g. new management rules or other new data from the template update, which rules and data are to be stored in the first storing means 310 or the database 360. The E-PLS 300 may also from a template update extract new values for data to be stored in a pen, which pen is updated with this data following its next request to the E-PLS 300 via the device interface 320. The parent PLS can be another E-PLS or the G-PLS. This enables the E-PLS 300 to also ask a parent PLS for a template update with data of a coded surface area that it currently has knowledge of.

Finally, the E-PLS 300 includes an E-PLS administration interface 370 via which an enterprise maintains and controls its E-PLS 300. The control may relate to the settings of the second storing means 340 for defining the position of the E-PLS in the hierarchy of E-PLSs, the access to and from other E-PLSs, and so on, in addition to general E-PLS security management. An operator of the enterprise preferably performs the administration by means of a web application executing within E-PLS 300.

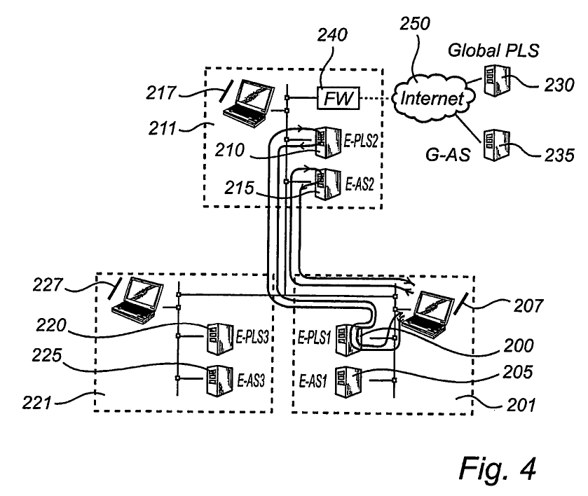

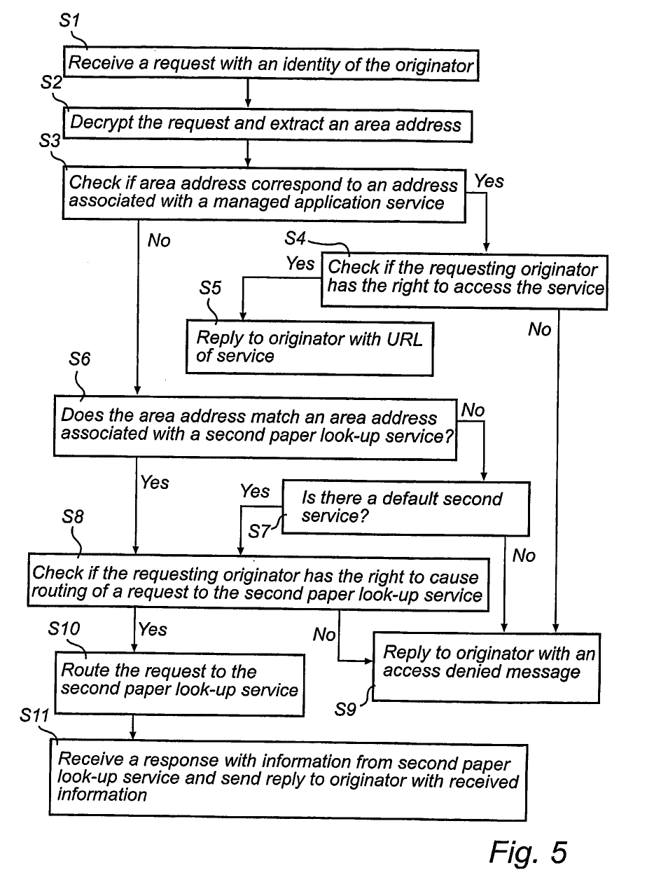

An exemplifying mode of operation of the present invention will now be described with reference to FIGS. 4 and 5. FIG. 4 correspond to the same hierarchy of PLSs as previously described with reference to the embodiment of FIG. 2, but with an illustration of the data/communication flow of the exemplified operation now to be described. FIG. 5 shows a flow chart with a number of operational steps, which flow chart illustrates some of the possible alternative flows that the operation of an E-PLS might undertake according to various embodiments thereof.

The overall operation starts when a pen user uses his pen 207 and “ticks” an activation icon on a position coded surface which is associated with an enterprise service. The pen 207 encrypts the request, except for the identity of the pen, using its own unique symmetrical cryptographic key, and sends the request to the E-PLS with which it is registered, also called the pen home PLS, in this case to E-PLS1.

The E-PLS1 receives (step S1) the request from the pen and extracts a non-encrypted identity of the pen. It then uses the pen identity to retrieve the pen's symmetrical cryptographic key with which it decrypts (step S2) the rest of the request and extracts an included area address of the surface area that the ticked activation icon belongs to. The E-PLS1 then checks (step S3) if the area address corresponds to a service in its list of managed enterprise application services E-AS1.

If a corresponding service is found, the E-PLS1 will check (step S4) if the requesting pen has a right to access the specific service. This check may, e.g., be performed by means of a stored two-dimensional matrix, formed by the digital pens registered with the E-PLS1 and the services managed by the E-PLS1, which matrix stores indications of which pens that have the right to access which services. Either the pen has the right to access the service, in which case the E-PLS1 will reply by sending (step S5) a URL for the service back to the pen, or the pen does not have the right, in which case the E-PLS1 respond (step S9) to the pen with an access denied.

Assuming in this example that there is no match in the list of services, the E-PLS1 will then check (step S6) if the area address match a second PLS in its list of externally available PLSs. Alternatively, or if there is no match, the E-PLS1 may check (step S7) if there is an external available default PLS. If there is no available default PLS, the E-PLS1 respond (step S9) to the pen with an access denied message. However, if there is an externally available matching PLS or default PLS, it is checked (step S8) if the pen has the right to cause routing of a request to the matching or default PLS. Also this check may be performed by means of a two-dimensional matrix, which matrix is formed by the registered digital pens and the PLSs to which the E-PLS1 is configured to be able to route a request. Should such routing not be allowed, the E-PLS1 respond (step S9) to the pen with an access denied message.

If routing to the matching or default PLS is allowed, the request is encrypted and routed (step S10) to the matching second PLS (or the default PLS). This request, or look-up request, includes the requesting E-PLS1's identity, the requesting pen's identity and the area address to which the activation icon belongs etc. In this case the E-PLS2 receives the request (once again step S1, but within the operation of E-PLS2), decrypts and authenticates it (step S2), and checks (step S3) if the area address corresponds to a service in its list of managed enterprise application services. Assuming there is a match, the E-PLS2 checks (step S8) that the service is not locked and that the requesting E-PLS1 has the right to cause routing of a request to the matching enterprise application service E-AS2. The E-PLS2 then replies to the requesting E-PLS1 with information that includes the URL for the matching service together with other information elements as described above with reference to FIG. 3.

The requesting E-PLS1 thus receives a response to its request from E-PLS2 (step S11, again within the operation of E-PLS1) and sends a response to the requesting pen 207. The response to the pen includes the URL for the matching service together with other information regarding, e.g., what kind of data that the device is required to transmit to the application service in order for the service to be executed, e.g. user data stored in the device or data recorded from a certain writing surface area. The pen 207 then uses the URL, and the other received information, to send a request to the enterprise application service E-AS2, which service processes the request and replies to the pen 207.

It is evident from the flow chart of FIG. 5, and from other parts of this invention disclosure, that a great number of alternative operation flows are possible while still falling within the scope of the appended claims and within the overall spirit and scope of the present invention.

1. A method of responding to a request for access to an application service, the application service being deployed in a system that associates a specific area of a position coded surface with an application service by means of an area address, the method including:
providing a first enterprise paper look-up service which manages a confined set of one or more enterprise application services associated with respective area addresses;
receiving, from an originator, a request including an area address;
checking, if the area address is associated with an enterprise application service managed by the first enterprise paper look-up service, that the originator of the request has the right to access the enterprise application service, before enabling access to the service; and
routing, based on the area address, the request to a second paper look-up service if the area address is not associated with an enterprise application service managed by the first enterprise paper look-up service.

2. The method of claim 1, wherein the routing step includes the step of selecting a second paper look-up service, among a plurality of paper look-up services, that is associated with the area address of the request.

3. The method as claimed in claim 2, wherein the selecting step is based on a step of matching the received area address with one of the area addresses which by the enterprise paper look-up service are associated with respective second paper look-up services.

4. The method as claimed in any one of claims 1-3, wherein the routing step includes the step of selecting a second paper look-up service that defines a default paper look-up service.

5. The method as claimed in any one of claims 1-4, including checking that the originator of the request has the right to cause routing of a request to the second paper look-up service, wherein said routing step only is completed if this right is confirmed.

6. The method as claimed in any one of claims 1-5, including:
receiving a response from the second paper look-up service;
extracting information related to the application service associated with the area address from the response; and
responding to the originator of the request by transferring said information to the originator.

7. The method as claimed in any one of claims 1-6, including determining that the originator is a digital device of the kind which is arranged to detect positions of the position coded surface, or a network connection unit in communication with such a digital device, which digital device is registered by the first enterprise paper look-up service.

8. The method as claimed in any one of claims 1-6, including determining that the originator is another enterprise paper look-up service.

9. The method as claimed in claim 6, wherein the information includes a network address designating the application service.

10. The method as claimed in claim 9, wherein the network address is designated by means of a Uniform Resource Locator.

11. The method as claimed in claim 6, wherein the information includes designations of mandatory data that the application service requires access to during its execution.

12. The method as claimed in any one of claims 1-11, wherein the second paper look-up service is another enterprise paper look-up service.

13. The method as claimed in any one of claims 1-11, wherein the second paper look-up service is a global paper look-up service providing world wide services to enterprise paper look-up services operated by various organisations, such as enterprises or government authorities.

14. The method as claimed in any one of claims 1-13, wherein the first paper look-up service together with the second paper look-up service is included in a hierarchy of paper look-up services.

15. The method as claimed in any one of claims 1-14, wherein the first enterprise paper look-up service performs the additional steps of:
requesting a global paper look-up service to provide any template updates; and
receiving a template update in response and extracting from the template update new management rules relating to at least one confined position coded surface area.

16. An enterprise paper look-up server for responding to a request for access to an application service, the application service being deployed in a system that associates a specific area of a position coded surface with an application service by means of an area address, the enterprise server including:
first storing means for storing associations between area addresses and respective enterprise application services defining a confined set of services managed by the enterprise server;
interface means for receiving, from an originator, a request including an area address;
processing means for checking, if the area address is associated with an enterprise application service managed by the enterprise paper look-up service itself, that the originator of the request has the right to access the enterprise application service, before enabling access to the service; and
routing means for routing, by means of the processing means and based on the area address, the request to a second paper look-up server if the area address is not associated with an enterprise application service managed by the enterprise paper look-up service itself.

17. The enterprise server as claimed in claim 16, which server includes second storing means for storing associations between area addresses and respective second paper look-up servers, and wherein the processing means is arranged for selecting a specific second paper look-up service which is associated with the area address of the request.

18. The enterprise server as claimed in claim 16 or 17, wherein the processing means is arranged to select a second paper look-up server that defines a default paper look-up server.

19. The enterprise server as claimed in any one of claims 16-18, wherein the processing means further is arranged for checking that the originator of the request has the right to cause routing of a request to the second paper look-up server, before said routing means completes the routing of the request.

20. The enterprise server as claimed in any one of claims 16-19, wherein said interface means further is arranged for receiving a response with information from the second paper look-up server and for responding to the originator of the request by transferring said information to the originator.

21. The enterprise server as claimed in any one of claims 16-20, wherein the processing means further is arranged for determining that the originator is a digital device of the kind which is arranged to detect positions of the position coded surface, or a network connection unit in communication with such a digital device, which digital device is registered at the enterprise paper look-up server.

22. The enterprise server as claimed in any one of claims 16-21, wherein the processing means further is arranged for determining that the originator is another enterprise paper look-up server.

23. The enterprise server as claimed in any one of claims 20-22, wherein the information include a network address designating the application service.

24. The enterprise server as claimed in claim 23, wherein the network address is designated by means of a Uniform Resource Locator.

25. The enterprise server as claimed in any one of claims 20-23, wherein the information include designations of mandatory data that the application service requires access to during its execution.

26. The enterprise server as claimed in any one of claims 16-25, wherein the second paper look-up server is another enterprise paper look-up server.

27. The enterprise server as claimed in any one of claims 16-25, wherein the second paper look-up server is a global paper look-up server providing world wide services to enterprise paper look-up servers operated by various organisations, such as enterprises or government authorities.

28. The enterprise server as claimed in any one of claims 16-27, which together with the second paper look-up server is included in a hierarchy of paper look-up servers.

29. The enterprise server as claimed in any one of claims 16-28, further including:
second interface means for requesting a global paper look-up service to provide any template updates and for receiving a template update in response thereto,
wherein said processing means is arranged for extracting from the template update new management rules relating to at least one confined position coded surface area.
